(19) United States
(12) Patent Application Publication
(10) Pub. No.: US 2026/0228189 A1
(43) Pub. Date: Aug. 6, 2026

(54) CLOUD PLATFORM METADATA SYNC

(71) Applicant: Walmart Apollo, LLC, Bentonville, AR (US)

(72) Inventors: Priya Narayana Prabhu, Bangalore (IN); Marcelin Mahimairaj Lovismartin, Glen Allen, VA (US); Vijayakumar Janakiraman, Aubrey, TX (US); Vamsi Krishna Kovuru, Frisco, TX (US)

(21) Appl. No.: 19/042,084

(22) Filed: Jan. 31, 2025

(51) Int. Cl. G06F 16/21; G06F 21/62

(52) U.S. Cl. CPC G06F 16/214; G06F 21/6218

(57) ABSTRACT

Examples provide a multi-platform metadata sync and catalog permission granting system using a single shared cloud storage used by a plurality of linked cloud platforms. When new data is created and stored on the shared cloud storage or existing data is deleted or updated on the shared cloud storage, metadata associated with the storage location of the data and permission data associated with access control permissions is extracted from the source system creating the changes. The extracted metadata is migrated substantially in real time to all the other linked cloud platforms. A copy of the extracted metadata is stored by each linked cloud platform. Each linked cloud platform can access the same copy of data stored on the shared cloud storage. This eliminates redundant duplication of data on the linked cloud platforms to reduce system resource usage consumed by copying and storing data.

### BACKGROUND

When migrating data from one platform to another, multiple copies of the data may be required. Data engineering teams have to create new pipelines to copy data for each domain, each table, and metadata across platforms. This adds to the costs of pipeline execution and operational support. This is duplicative, time-consuming, and burdensome to users.

### SUMMARY

Some examples provide a system for multi-platform metadata sync with a single shared data storage. A single copy of source data generated on a source system is stored on a shared cloud storage. The copy of the source data on the shared cloud storage is accessible by a plurality of linked cloud platforms, including the source system and a target system. Asset creation metadata for the single copy of the source data is extracted from a source audit log of the source system. The extracted asset creation metadata includes location-specific metadata associated with a location of the single copy of the source data on the shared cloud storage. The extracted asset creation metadata is migrated to a target audit log on a target database associated with the target system. A first entity associated with the target system utilizes the extracted asset creation metadata to access the single copy of the source data on the shared cloud storage. The single copy of the source data is accessible to a plurality of entities associated with the plurality of linked cloud platforms via the shared cloud storage without duplicating the source data on each cloud platform in the plurality of cloud platforms.

Other examples provide a method for multi-platform metadata sync with a single shared data storage. Source data generated on a source system in a plurality of linked cloud platforms associated with a shared cloud storage is identified. A single copy of the source data is stored on the shared cloud storage. The single copy of the source data stored on the shared cloud storage is accessible by a plurality of linked cloud platforms, including the source system and a target system. Asset creation metadata is extracted from a source audit log of the source system. The extracted asset creation metadata includes location-specific metadata associated with a location of the single copy of the source data on the shared cloud storage. The extracted asset creation metadata is migrated to a target audit log on a target database associated with the target system. Access to the copy of the source data is provided to any entity associated with the target system utilizing the extracted asset creation metadata to access the copy of the source data on the shared cloud storage.

Still other examples provide a computer storage devices having computer-executable instructions stored thereon, which, upon execution by a computer, cause the computer to identify source data generated on a source system in a plurality of linked cloud platforms associated with a shared cloud storage; store a single copy of the source data on the shared cloud storage; extract asset creation metadata associated with the single copy of the source data on the shared cloud storage from a source audit log of the source system; migrate the extracted asset creation metadata to a target audit log on a target database associated with the target system; and provide access to an entity associated with the target system utilizing the extracted asset creation metadata to access the single copy of the source data on the shared cloud storage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for multi-platform metadata synchronization and permission grant with a shared cloud storage.

FIG. 2 is an exemplary block diagram illustrating a system for metadata synchronization across multiple platforms linked to a shared cloud storage.

FIG. 3 is an exemplary block diagram illustrating a sync manager for synchronizing metadata from a source platform to a target platform.

FIG. 4 is an exemplary block diagram illustrating a system for synchronization of asset creation metadata enabling a source platform and a target platform to utilize a single copy of data in a shared cloud storage.

FIG. 5 is an exemplary block diagram illustrating a system for metadata and permission grant synchronization across a plurality of platforms.

FIG. 6 is an exemplary block diagram illustrating a system for grant permission associated with a single copy of data on a shared cloud storage across multiple platforms.

FIG. 7 is an exemplary flow chart illustrating operation of the computing device to synchronize asset creation metadata across multiple platforms.

FIG. 8 is an exemplary flow chart illustrating operation of the computing device to enable access control to a single copy of data in a shared cloud storage across multiple platforms.

FIG. 9 is an exemplary flow chart illustrating operation of the computing device to link a candidate cloud platform to a shared cloud storage linked to multiple platforms.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Users frequently utilize multiple cloud platforms to perform various data analysis projects using multiple data presentation formats. There have been recurring incidences when data processing is to be done on a first cloud platform and the required data is stored in a second, different cloud platform and vice versa. Users are required to copy the data from one cloud platform to another cloud platform causing higher operational costs and potentially deduplication of data. Data engineering teams typically are required to use multiple pipelines for this process.

Ensuring data availability and accessibility across cloud solutions consistently can be a difficult challenge. This often results in redundant data copies and complex processes for syncing metadata, leading to multiple access control processes. For example, synchronizing metadata and access control between a source cloud platform and a target cloud platform.

Managing metadata and access to users across multiple cloud offerings is complex. Data pipelines must be developed for creating and replacing metadata. Incremental metadata updates require ongoing support. This results in additional development effort and higher data pipeline costs. Monitoring and synchronization of metadata present further challenges. Changes in metadata results in systems becoming out of synchronization and changes in access control makes it difficult to access the data to which the metadata refers. Cloud platforms involved in the cloud solutions do not currently offer any solution to solve these problems. Moreover, existing solutions incur additional costs.

Referring to the figures, examples of the disclosure enable a data sync manager tool for automatically syncing data between different cloud platforms and providing data access control between platforms. In some examples, a sync manager extracts asset creation metadata from audit files of a source cloud platform that has created new data on the shared cloud server, deleted data, or otherwise modified data on the shared cloud platform. The metadata includes access permission data, such as active directory information, authentication data, and authorization data for the data on the shared cloud platform. The metadata, in other embodiments, also includes details on asset information and permission.

The metadata is extracted and migrated to all target platforms in near real time, enabling all linked platforms access to a single version of data while reducing errors due to failure to timely update asset creation metadata on the target platforms. This enables reduced system resource usage, specifically, reduced usage of storage resources, network bandwidth usage, and memory usage where a single copy of data is maintained instead of copying the same data into every platform in a plurality of cloud platforms that require access to the data. This further reduces system resource usage which would be consumed updating metadata on all the platforms each time a change is made to the metadata either by deleting some metadata or by adding some metadata.

Aspects of the disclosure further enable linking multiple cloud platforms to a single cloud storage platform for storing data shared by all the linked cloud platforms without creating a separate copy of the data and access control data for each different platform. This further conserves memory and increases the speed with which data utilized by multiple platforms can be updated while reducing errors which might otherwise occur when data is copied into multiple different locations for utilization by different platforms.

The computing device operates in an unconventional manner by migrating metadata associated with source data generated on a source platform to one or more target platforms in a plurality of linked platforms utilizing a common shared cloud storage. In this manner, the computing device is used in an unconventional way and allows reduced system resource usage and greater efficiency managing data shared by multiple entities on multiple different cloud platforms, thereby improving the functioning of the underlying computing device.

Other embodiments automatically update audit logs on all target cloud platforms whenever a source cloud platform writes data, deletes data, or modifies data on the shared cloud platform. In this manner, a user can quickly assess any changes to the data and ensure metadata migrations are correct and complete. Users can view the updated audit logs which depicts which assets is published in the target platform via a dashboard exposed to the user via a user interface (UI). This enables improved user efficiency via UI interaction and increased user interaction performance.

The system, in some embodiments, provides a data sync manager that can sync metadata and grant permissions seamlessly irrespective of the cloud platform. This provides faster and more efficient data migration and syncing across cloud platforms in a platform agnostic manner.

The data sync manager tool, in other embodiments, provides a common platform to synchronize meta data between multiple platforms and grant permissions to access data in the linked platforms. This platform can function like a metadata bridge. The data sync manager tool streams the data from multiple cloud platforms which further allows processing the streamed data for asset creation using query generator from a common platform.

The system, in some embodiments, eliminates the need for multiple pipelines to migrate data between disparate cloud platforms. Thus, a separate pipeline is not needed for any domain. The tool eliminates or minimizes duplication of metadata. In addition, data is only copied once. Data is not duplicated multiple times. This greatly reduces system resource usage, such as by reducing memory usage, reducing data storage device usage, reducing processor and network bandwidth usage consumed during data migration, as well as reducing time and expense associated with migrating data between different cloud platforms.

In other embodiments, the data sync manager streamlines metadata sync processes, reducing manual tasks and increasing automation and reducing operating costs. The data sync manager tool further enhances productivity by reducing repetitive tasks like pipeline creation for metadata and granting permission. The data sync manager tool enables immediate availability of metadata(tables, views) and single role for access control across multiple cloud offerings for simplified access control and metadata timeliness. The system is a highly scalable solution and can be extended to other federated data cloud offerings for cost efficiency and improved metadata automation. The system further provides a single copy of data accessible by multiple platforms and continuously updated eliminating out-of-sync data issues while eliminating data migration issues across disparate cloud platforms.

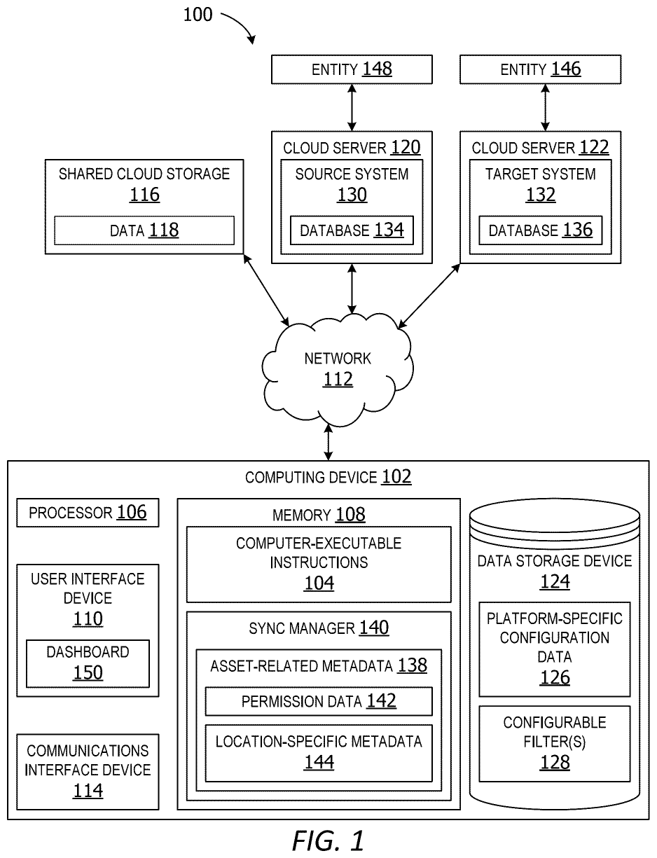

Referring again to FIG. 1, an exemplary block diagram illustrates a system 100 for multi-platform metadata synchronization and permission grant with a shared cloud storage. In the example of FIG. 1, the computing device 102 represents any device executing computer-executable instructions 104 (e.g., as application programs, operating system functionality, or both) to implement the operations and functionality associated with the computing device 102. The computing device 102, in some examples, includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

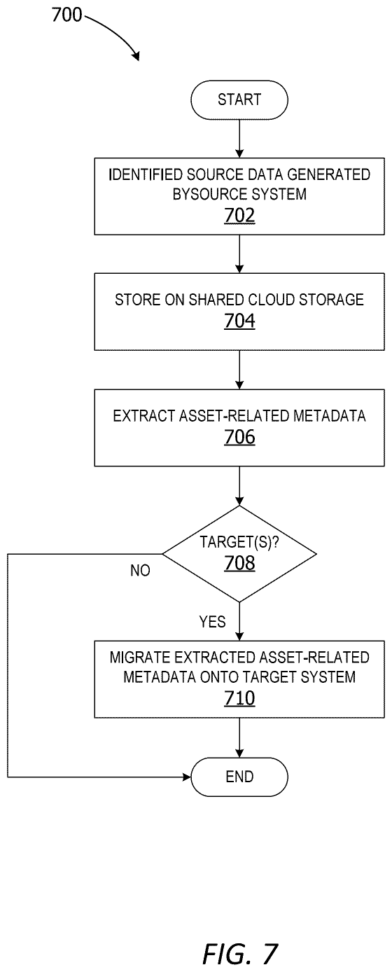

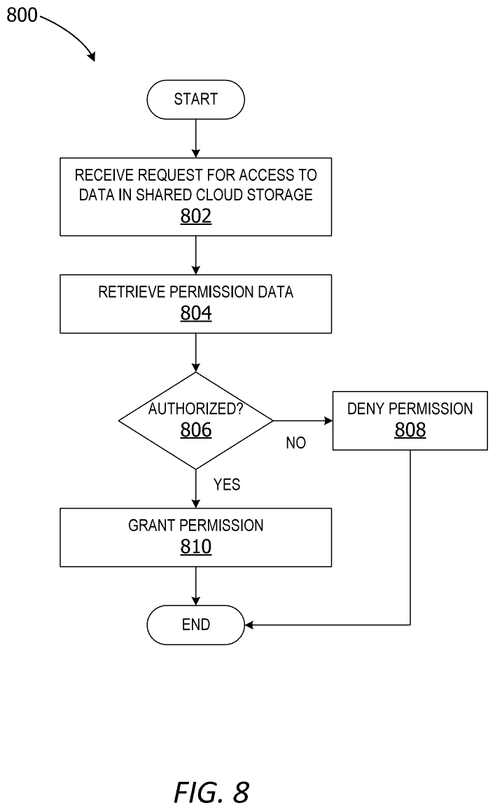

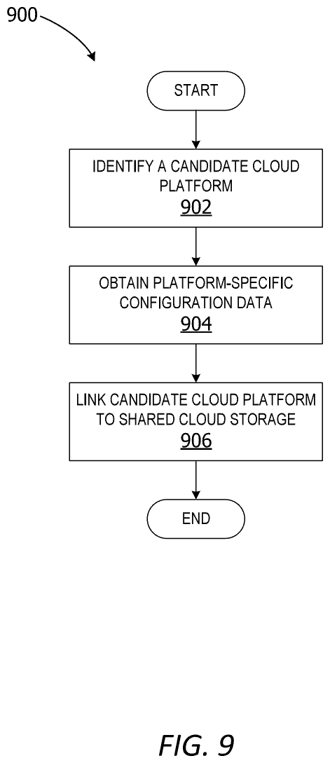

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 7, FIG. 8, and FIG. 9).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a shared cloud storage 116 and/or a cloud server, can occur using any protocol or mechanism over any wired or wireless connection. In some examples, the communications interface device 114 is operable with short range communication technologies such as by using near-field communication (NFC) tags.

The shared cloud storage 116 is a data storage implemented on a cloud platform. The shared cloud storage stores a single copy of data, such as, but not limited to, the data 118. The data 118 includes any type of data, such as, but not limited to, data in a table, database, view, schema, or any other type of data.

A cloud server, such as the cloud server 120 and/or the cloud server 122, is a logical server providing services to the computing device 102 or other clients, such as, but not limited to, a user device. The shared cloud storage 116, the cloud server 120 and/or the cloud server 122 is hosted and/or delivered via the network 112. In some non-limiting examples, the shared cloud storage 116, the cloud server 120 and/or the cloud server 122 is associated with one or more physical servers in one or more data centers. In other embodiments, the shared cloud storage 116, the cloud server 120 and/or the cloud server 122 is associated with a distributed network of servers.

The system 100 can optionally include a data storage device 124 for storing data, such as, but not limited to platform-specific configuration data 126 and/or configurable filter(s) 128. The platform-specific configuration data 126 includes configuration data for linking a source system 130 on the cloud server 120 and/or a target system 132 on the cloud server 122 to the shared cloud storage 116, such that the source system 130 and the target system 132 can both access a single copy of the data 118 on the shared cloud storage 116. The source system is a source of the data 118 which is stored on the shared cloud storage 116 and/or a source of an update to the data 118. The target system is a system which is being synchronized to ensure the target system can access the data 118 on the shared cloud storage 116.

In these embodiments, the source system 130 does not maintain a separate copy of the data 118 on the database 136 or other data storage device or data storage structure associated with the cloud server 120. Additionally, the target system 132 does not maintain a separate copy of the data 118 on the database 136 or other data storage device or data storage structure associated with the target system 132 on the cloud server 122.

The configurable filter(s) 128 include one or more filters for extracting relevant asset creation metadata 138 from a source audit log stored on the source system 130 database 134 of the source system 130 prior to updating the target audit log stored on the target system 132 database 136 on the cloud server 122. The asset-related metadata 138 includes metadata associated with assets and asset creation. An asset include any type of system asset, such as, but not limited to, tables, views, databases, etc.

The configurable filter(s) 128 enable the sync manager 140 to extract and filter metadata pulled from the source system 130 to ensure the metadata is in the proper format for storage and use by the target system 132. The extracted and filtered asset creation metadata 138 includes permission data 142 for authenticating and authorizing an entity attempting to access the copy of the data 118 on the shared cloud storage from the target system 132 and/or location-specific metadata 144 enabling the target system 132 to locate the data 118 on the shared cloud storage 116.

The data storage device 124 can include one or more different types of data storage devices, such as, for example, one or more rotating disks drives, one or more solid state drives (SSDs), and/or any other type of data storage device. The data storage device 124 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 124 includes a database.

The data storage device 124 in this example is included within the computing device 102, attached to the computing device, plugged into the computing device, or otherwise associated with the computing device 102. In other examples, the data storage device 124 includes a remote data storage accessed by the computing device via the network 112, such as a remote data storage device, a data storage in a remote data center, or a cloud storage.

The memory 108 in some examples stores one or more computer-executable components, such as, but not limited to, the sync manger 140. The sync manager 140, in some embodiments, is executed by the processor 106 to store a single copy of source data, such as the data 118, generated on a source system 130 to the shared cloud storage 116. The single copy of the source data stored on the shared cloud storage is accessible by a plurality of linked cloud platforms, such as, but not limited to, the source system 130 and/or the target system 132. The plurality of linked cloud platforms, in this example, include the source system 130 implemented on the cloud server 120 and/or the target system 132 implemented on the cloud server 122.

In some embodiments, the sync manager 140 extracts asset creation metadata 138 for the single copy of the data 118 on the shared cloud storage 116 from a source audit log on a source database 134 associated with the source system 130. The sync manager 140 migrates the extracted asset creation metadata 138 to the target audit log on a target database 136 associated with the target system 132. A first entity 146 associated with the target system 132 utilizes the extracted asset creation metadata 138 copied onto the source database 136 to access the same copy of the data 118 on the shared cloud storage 116. The entity 146 and/or the entity 148 is any type of entity utilizing the data 118, such as, but not limited to, a user, an application, a process, an algorithm, or any other type of entity.

The data 118 is accessible to a plurality of entities associated with the plurality of linked cloud platforms via the shared cloud storage 116 without duplicating the source data on each cloud platform in the plurality of cloud platforms. The plurality of entities includes an entity 146 associated with the target system 132 and/or an entity 148 accessing the data 118 via the source system 130.

In this example, the sync manager 140 is located on a computing device 102. In other embodiments, the sync manager 140 is implemented on a cloud server, such as, but not limited to, the cloud server 120 and/or the cloud server 122.

Data environments often involve frequent table and view creation. The sync manager 140, in some embodiments, provides a cloud-agnostic solution to automatically propagate metadata across multiple cloud offerings, ensuring seamless access for users to data from a single location on the shared cloud storage 116, regardless of the cloud solutions. In some embodiments, the system 100 automatically creates and updates metadata tables, schemas, and views on the source system 130 and/or on the target system 132. The system 100 seamlessly grants access permission across cloud solutions for syncing metadata from one cloud platform to a shared data store, such as the shared cloud storage 116, accessible by a plurality of different cloud platforms negating the need for copying data from one cloud platform to other different cloud platforms. The plurality of different cloud platforms in this example includes two cloud platforms, the target system 132 and the source system 130. However, in other embodiments, the plurality of different cloud platforms includes three or more cloud platforms.

The shared cloud storage 116 in this example is a data storage on a cloud platform on a cloud server. However, in other embodiments, the shared cloud storage is a data storage on a physical data storage device, such as, but not limited to, the data storage device 124.

In some embodiments, the sync manager 140 provides a live dashboard 150 for creation of tables, views status, etc. The dashboard 150 is presented to the user via a user interface (UI), such as, but not limited to, the user interface device 110. The dashboard 150 surfaces data to the user(s), such as, but not limited to, notifications associated with migrated metadata, audit log updates, etc.

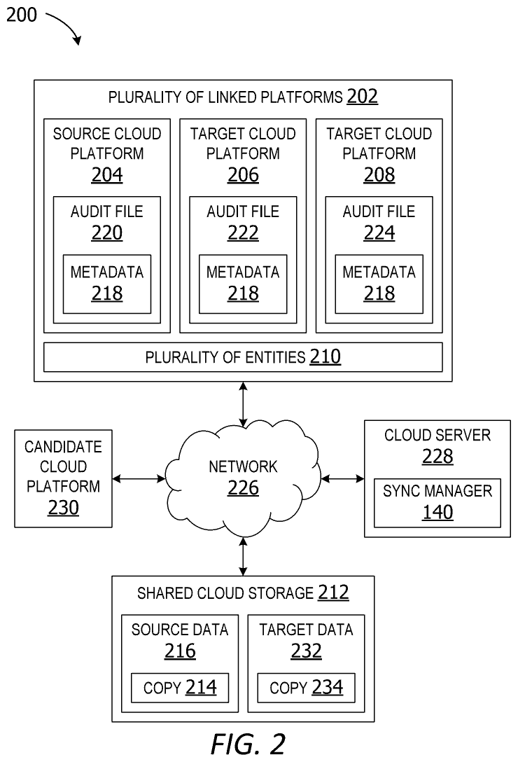

FIG. 2 is an exemplary block diagram illustrating a system 200 for metadata synchronization across multiple platforms linked to a shared cloud storage. The system 200 is a system including a sync manager 140, such as, but not limited to, the system 100 in FIG. 1.

A plurality of linked platforms 202 includes a source cloud platform 204 and one or more target cloud platforms, such as, but not limited to, a target cloud platform 206 and/or the target cloud platform 208. The source cloud platform 204, the target cloud platform 206, and the target cloud platform 208 are systems on a cloud platform, such as, but not limited to, the cloud server 120 and/or the cloud server 122 in FIG. 1.

The plurality of linked platforms 202 are utilized by a plurality of entities 210. An entity in the plurality of entities 210 includes any type of user, application, process, or other entity, such as, but not limited to, the entity 146 and/or the entity 148 in FIG. 1.

The plurality of linked platforms 202 include two or more cloud platforms linked to a shared cloud storage 212. The shared cloud storage 212 is a common data store utilized by multiple cloud platforms, such as, but not limited to, the shared cloud storage 116 in FIG. 1.

In this example, the source cloud platform 204 stores a copy 214 of source data 216 on the shared cloud storage 212. The source data 216 is data generated on a source system associated with the source cloud platform 204, such as, but not limited to, the data 118 in FIG. 1. The sync manager 140 extracts metadata 218 streamed from an audit file 220 on the source cloud platform 204. The metadata 218 includes permission data and/or location-specific metadata describing the source data 216 stored on the shared cloud storage 212.

The extracted metadata 218 is filtered and/or formatted as necessary for the target cloud platforms in the plurality of linked platforms 202. The extracted metadata 218 is stored on a data storage associated with each of the target cloud platforms on the plurality of linked platforms 202. A target cloud platform is a cloud platform in the plurality of linked platforms that is being updated with metadata associated with the source data 216, such as, but not limited to, the target system 132 on the cloud server 122 in FIG. 1. In this example, the target cloud platforms include the target cloud platform 206 and/or the target cloud platform 208.

The sync manager 140 processes the metadata 218 from the source cloud platform 204 audit file 220 to the audit file 222 and/or the audit file 224 of the target cloud platform 208. This metadata synchronization between the source cloud platform 204 and the target cloud platforms is performed by the sync manager 140 via the network 226. The network 226 is a communications network enabling sending and/or receiving of data between the cloud server 228, the plurality of linked platforms 202, the shared cloud storage 212 and/or a candidate cloud platform 230.

The candidate cloud platform 230 is a cloud platform which is currently not linked to the shared cloud storage. The candidate cloud platform 230 is onboarded into the plurality of linked platforms 202 using platform-specific configuration data for the candidate cloud platform 230, such as, but not limited to, the platform-specific configuration data 126 in FIG. 1.

In other embodiments, if the target cloud platform 206 generates target data 232 on the target cloud platform 206, a single copy 234 of the target data 232 is stored on the shared cloud storage 212. The sync manager 140 updates the metadata associated with the copy 234 of the target data 232 on the shared cloud storage 212 in the audit files of each cloud platform in the plurality of linked platforms 202. In this manner, only the metadata used to locate the target data and access the target data 232 is copied to each of the linked cloud platforms. Only a single copy 234 of the target data 232 is maintained on the shared cloud storage which is accessible by entities utilizing the plurality of linked platforms 202. A copy of the target data 232 is not created on each of the linked platforms. This reduces system resource usage by the plurality of linked platforms 202 while ensuring entities accessing the copy of the source data 216 and/or the copy 234 of the target data 232 are seeing the same data regardless of which cloud platform in the plurality of linked platforms is utilized when viewing or otherwise accessing the data.

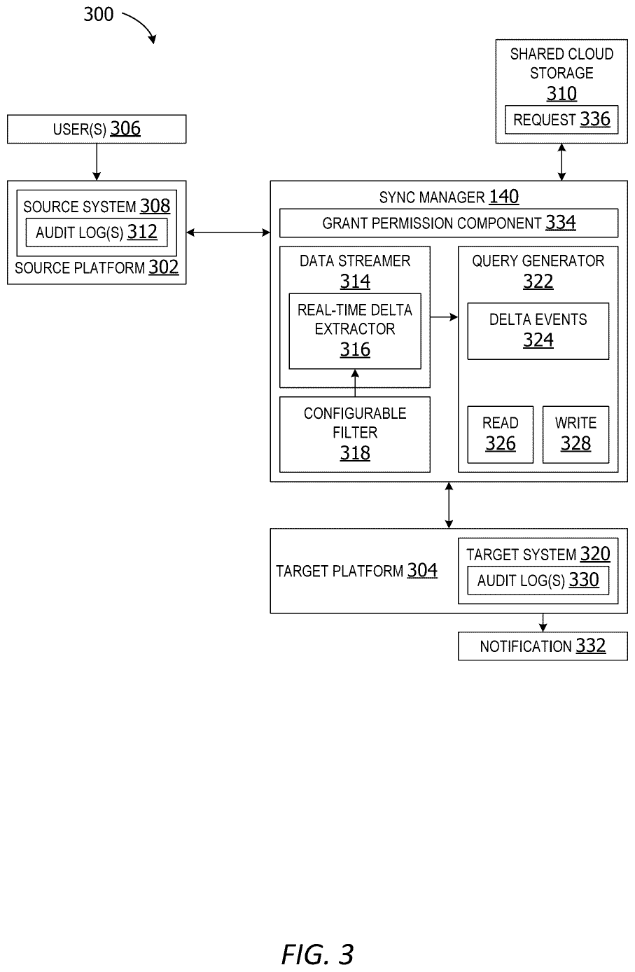

Turning now to FIG. 3, an exemplary block diagram illustrating a system 300 including a sync manager 140 for synchronizing metadata from a source platform 302 to a target platform 304 is shown. The system 300 is a system for synchronizing metadata across cloud platforms, such as, but not limited to, the system 100 in FIG. 1 and/or the system 200 in FIG. 2.

In this example, one or more user(s) 306 are utilizing a source system 308 implemented on a source platform 302. The source platform 302 is a cloud platform on a cloud server, such as, but not limited to, the cloud server 120 in FIG. 1. The source system 308 is any type of system, such as, but not limited to, a database system, a machine learning (ML) system, an enterprise system, an inventory system, or any other type of system. Data generated on the source system 308 is stored on a shared cloud storage 310. The shared cloud storage 310 is a data store maintained on a cloud server, such as, but not limited to, the shared cloud storage 116 in FIG. 1 and/or the shared cloud storage 212 in FIG. 2. The metadata associated with the data is stored in one or more audit log(s) 312 on the source system 308 and/or on a data storage device associated with the source system 308.

A data streamer 314 extracts the metadata from the source system 308. In some embodiments, the data streamer 314 includes a real-time delta extractor 316 which extracts the metadata from a data stream in real-time using a pull request. In other embodiments, a configurable filter 318 is applied to filter out extraneous data and/or format the extracted data into an acceptable format compatible with a target system 320 on the target platform 304.

In some embodiments, the data streamer 314 streams data from the source audit log(s) 312, reads the audit log(s) 312, and extracts relevant information from the streamed data from the source audit log(s) 312. The audit log(s) can include an audit table, a database, a schema, a view, or any other data storage structure.

A query generator 322 creates one or more queries from the streamed data associated with delta events 324, such as read 326 and write 328 events. The query generator 322 creates statements for the queries compatible with the target platform 304. The audit log(s) 330 is updated to include the metadata extracted from the source system audit log(s) 312. A notification 332 is output to one or more users notifying the user(s) of the update to the audit log(s) 330. The notification 332 is surfaced to the user(s) via an email, a message, or other alert. In some embodiments, the notification 332 is provided via a dashboard interface, such as, but not limited to, the dashboard 150 in FIG. 1.

When a user or other entity associated with the target system 320 wants to access the source data in the shared cloud storage using the metadata, a request 336 is sent including the metadata. The request optionally also includes authentication and/or authorization data to authenticate and authorize the entity for the access. A grant permission component 334 utilizes the metadata and the authentication and authorization data to determine whether to grant or deny access to the data to the requesting entity associated with the target system 320.

In this example, metadata is extracted from audit log(s) on a source system and migrated to audit log(s) on one or more target systems. However, the embodiments are not limited to extracting metadata from audit logs and/or synchronization of metadata on audit logs. In other embodiments, the metadata is extracted from any type of data storage structure associated with the source system and migrated to any type of data storage structure for storing asset creation metadata associated with one or more target systems.

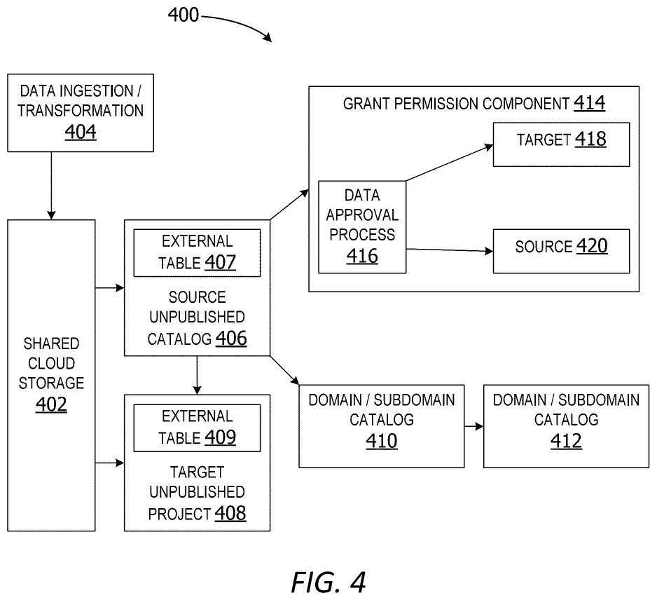

FIG. 4 is an exemplary block diagram illustrating a system 400 for synchronization of asset creation metadata enabling a source platform and a target platform to utilize a single copy of data in a shared cloud storage 402. The system 400 is a system such as, but not limited to, the system 100 in FIG. 1, the system 200 in FIG. 2, and/or the system 300 in FIG. 3. The shared cloud storage 402 is a shared data store utilized by linked cloud platforms, such as, but not limited to, the shared cloud storage 116 in FIG. 1, the shared cloud storage 212 in FIG. 2, and/or the shared cloud storage 310 in FIG. 3.

The shared cloud storage 402 ingests data from one or more source systems at 404. Metadata associated with the source data is optionally stored in the shared cloud storage 402. A source unpublished catalog 406 optionally includes one or more external data tables, such as, but not limited to, an external table 407. A target unpublished project 408 optionally includes one or more external tables providing unified interface for analytics and AI engines, such as, but not limited to, an external table 409. The source system domain/subdomain catalog 410 optionally includes general view for accessing non-sensitive data and secure/safe views for accessing sensitive and highly sensitive data. A target system domain/subdomain catalog 412 optionally includes a general view and/or secure/safe view.

Metadata, in some embodiments, is extracted from one or more source audit log(s) and synchronized in the audit log(s) of the target system at 408 by the sync manager. Metadata extracted from the source system is converted into a format suitable to the target system. In other embodiments, a grant permission component 414 of the sync manager performs data approval process 416 for access approval to determine whether to grant or deny access to a requesting entity. The grant permission component 414 utilizes permission data to determine whether to grant permission of specific data on the shared cloud storage associated with a target 418 and/or a source 420 to a specific requesting entity on a linked cloud platform or deny the permission based on data provided in the access request. Access can be granted in a general view or in a secure/safe view depending on the scope of access granted to the requester.

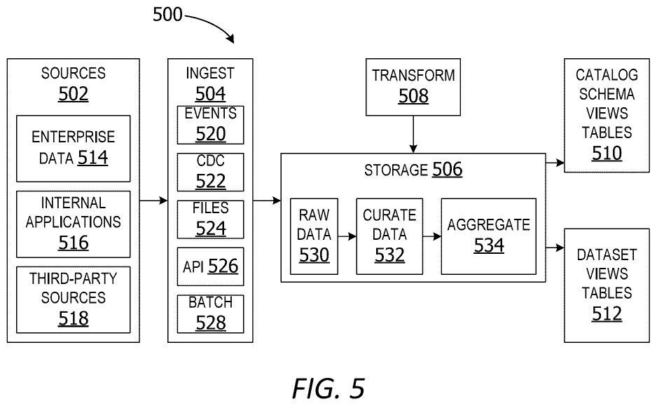

FIG. 5 is an exemplary block diagram illustrating a system 500 for metadata and permission grant synchronization across a plurality of platforms. The system 500 is a system for synchronizing metadata, such as, but not limited to, the system 100 in FIG. 1, the system 200 in FIG. 2, the system in FIG. 3, and/or the system in FIG. 4. A source system generates source data from one or more sources 502 which is stored on a shared cloud storage 506. The sources 502 include data, such as, but not limited to, enterprise data 514, internal applications 516, and/or data associated with third-party sources 518.

In some embodiments, metadata associated with the source data is ingested at 504. The ingested data can include, for example, events 520, change data capture (CDC) 522, Files 524, application programming interface (API) 526 data and/or batch 528 data. The data is optionally transformed at 508. The raw data 530 is curated at 532. The curated data is aggregated at 534. The data transformation can optionally also include filtering, formatting, or other transformation of the metadata to suit the requirements of the source system 510 and/or the target system 512 that is receiving synchronize metadata.

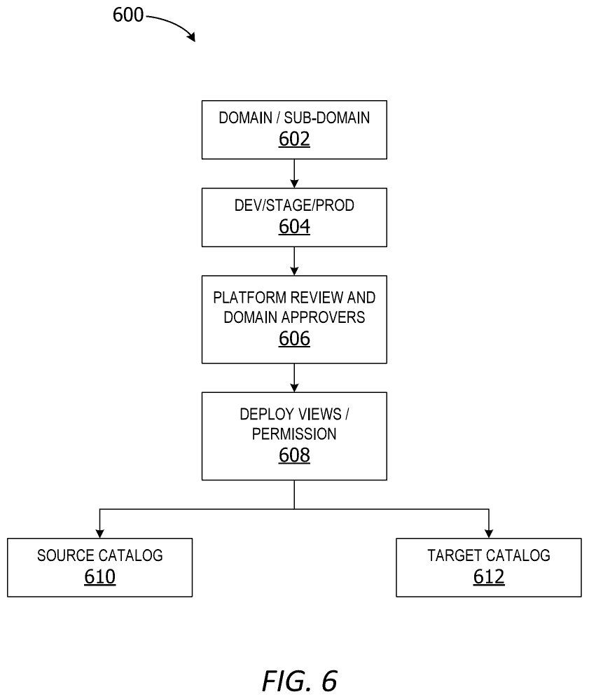

Referring to FIG. 6, an exemplary block diagram illustrating a system 600 for permission grant associated with a single copy of data on a shared cloud storage across multiple platforms. The system is a system for performing access control associated with access to a copy of data on a shared cloud storage linked to multiple cloud platforms. The permission grant is performed by a sync manager, such as the sync manager 140 in FIG. 1, FIG. 2, and/or FIG. 3. In this example, an entity associated with a given domain and/or sub-domain 602 makes a request to access data stored on the shared cloud storage. The requesting system environment can include a development, stage and/or production environment 604. A platform review and domain approvers are implemented at 606. Views and/or permissions are deployed at 608. Access is granted or denied to data on the shared cloud storage, such as but not limited to, the source catalog 610 and/or a target database 612.

FIG. 7 is an exemplary flow chart illustrating operation of the computing device to synchronize asset creation metadata across multiple platforms. The process 700 shown in FIG. 7 is performed by a sync manager component, executing on a computing device, such as, but not limited to, the computing device 102 in FIG. 1.

The process begins by identifying source data generated on a source system at 702. The source data is stored on a shared cloud storage at 704. The source data is data such as, but not limited to, the data 118 in FIG. 1 and/or the source data 216 in FIG. 2. Asset creation metadata is extracted from the source system at 706. The asset creation metadata is data including location-specific metadata and/or permission data, such as, but not limited to, the asset creation metadata 138 in FIG. 1. A determination is made whether any target systems require synchronization at 708. If yes, the extracted asset creation metadata is migrated onto the target system at 710. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to enable access control to a single copy of data in a shared cloud storage across multiple platforms. The process 800 shown in FIG. 8 is performed by a sync manager component, executing on a computing device, such as, but not limited to, the computing device 102 in FIG. 1.

The process begins by receiving a request for access to data in a shared cloud storage at 802. The shared cloud storage is a data store such as, but not limited to, the shared cloud storage 116 in FIG. 1, the shared cloud storage 212 in FIG. 2, the shared cloud storage 310 in FIG. 3, the shared cloud storage 402 in FIG. 4, and/or the shared cloud storage 506 at FIG. 5. Permission data is retrieved at 804. The permission data associated with access control permission data such as, but not limited to, the permission data 142 in FIG. 1. In some examples, the permission data includes an active directory. A determination is made as to whether the entity requesting access is authorized at 806. The determination can include determining whether the entity is authenticated and authorized. If not, the permission is denied at 808. The process terminates thereafter. If the entity is authorized at 806, permission is granted at 810. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an exemplary flow chart illustrating operation of the computing device to link a candidate cloud platform to a shared cloud storage linked to multiple platforms. The process 900 shown in FIG. 9 is performed by a sync manager component, executing on a computing device, such as, but not limited to, the computing device 102 in FIG. 1.

The process begins by identifying a candidate cloud platform at 902. The candidate cloud platform is a cloud platform or system associated with a cloud platform to be linked to a shared cloud storage at 902. Platform-specific configuration data is obtained at 904. The platform-specific configuration data is data specific to the candidate cloud platform which is utilized to configure the candidate cloud platform for synchronization of metadata. The candidate cloud platform is linked to the shared cloud storage at 906. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

### ADDITIONAL EXAMPLES

In some embodiments, the system provides a cloud agnostic tool for syncing metadata and granting catalog permission across cloud platforms, enabling data to be kept in one place with the data available in multiple platforms, such as, but without limitation a Databricks® cloud platform and/or a BigQuery® cloud platform. New cloud platforms (candidate cloud platforms) can be added by updating configuration data used by the data sync manager that corresponds with the new platforms. The data sync manager tool creates, updates, and grants permission to tables and views irrespective of data engineering solutions used. Data is not duplicated multiple times. For example, a table created in a catalog within a source cloud platform is automatically synced within a single data storage of the tool which is linked to and accessible by another different target cloud platform. It creates tables for all catalogs, tables, views, and projects on two or more different cloud platforms automatically, simultaneously and in real-time. This enables the data sync manager tool to synchronize meta data between multiple platforms and grant permissions to access data between the linked cloud platforms. This platform can function like a metadata bridge. The tool can further create audit tables that can be verified and accessed through the linked platforms.

Other embodiments provide a cloud platform agnostic data sync manager tool for maintaining a single copy of data that is accessible by multiple cloud platforms. The data sync manager tool automatically creates, updates, and grants permission to schema, table and/or views which gets created in a first cloud platform which is also accessible by a second, different cloud platform, and vice versa.

The system, in some embodiments, creates a single copy of data that is to be migrated between different cloud platforms and replicates it (make the data available/accessible) to other platforms eliminating the need to duplicate the data in multiple locations. The data creation and update are done in real time and periodically updated in real-time.

The system, in other embodiments, provides two technical capabilities are provided through the metadata sync manager tool, including a unity data streamer and query generator, that allows the tool to stream the data and query the streamed data. The unity data streamer module reads audit logs and extracts information to sync data. The query generator can function as, for example, create data definition language (DDL) statements for structured query language (SQL) query compatible with a specific source cloud platform and/or a target cloud platform. SQL is a domain-specific language used to manage data, especially in a relational database management system. It is particularly useful in handling structured data, i.e., data incorporating relations among entities and variables. The synchronization of metadata occurs seamlessly in real time providing a unified governance solution for data and artificial intelligence (AI) assets on cloud platforms.

Still other embodiments provide source cloud platform to target cloud platform metadata sync up with improved access management. The system enables catalog access permission grant using metadata synchronization for domain assets. Other embodiments provide a live dashboard for the creation of tables, views, notifications, status updates, etc.

Alternatively, or in addition to the other examples described herein, examples include any combination of the following:
the extracted F further comprises permission data for granting permission to the single copy of the source data.
receive a request for access to the single copy of the source data from a requesting entity associated with a platform in the plurality of linked cloud platforms;
determine whether an entity associated with the request is authorized to access the single copy of the source data using the permission data;
responsive to determining the requesting entity is authorized, grant permission for the entity to access the single copy of the source data;
responsive to determining whether the requesting entity is unauthorized based on the permission data, deny permission to access the single copy of the source data;
receive a copy of target data generated on the target system to the shared cloud storage;
extract second asset creation metadata associated with the received copy of the target data on the shared cloud storage from the target audit log, wherein the second extracted asset creation metadata comprises second location-specific metadata associated with a second location of the received copy of the target data on the shared cloud storage;
migrate the second asset creation metadata to the source audit log, wherein a second entity associated with the source system utilizes the second asset creation metadata to access a single copy of the received target data on the shared cloud storage;
identify a candidate cloud platform to be added to the plurality of linked cloud platforms;
obtain platform-specific configuration data associated with the candidate cloud platform;
link the candidate cloud platform to the shared cloud storage using the platform-specific configuration data, wherein asset creation metadata for accessing data stored on the shared cloud storage is migrated onto a database associated with the candidate cloud platform;
migrate the extracted asset creation metadata to each target audit log associated with each target system in a plurality of target systems within the plurality of linked cloud platforms, wherein a plurality of entities associated with the plurality of target systems is provided with access to a same version of the source data on the shared cloud storage via the single copy of the source data stored on the shared cloud storage;
filter the extracted asset creation metadata using a set of platform-specific configurable filters associated with the target system;
query streaming data from the source system substantially in real-time for information from the audit log;
extract the asset creation metadata from the streaming data;
create a metadata table in the target database of the target system;
synchronize the asset creation metadata in the target data using the extracted asset creation metadata;
identifying source data generated on a source system in a plurality of linked cloud platforms associated with a shared cloud storage;
storing a single copy of the source data on the shared cloud storage, the single copy of the source data stored on the shared cloud storage is accessible by a plurality of linked cloud platforms, the plurality of linked cloud platforms including the source system and a target system;
extracting asset creation metadata associated with the single copy of the source data on the shared cloud storage from a source audit log of the source system, wherein the extracted asset creation metadata comprises location-specific metadata associated with a location of the single copy of the source data on the shared cloud storage;
migrating the extracted asset creation metadata to a target audit log on a target database associated with the target system;
providing access to an entity associated with the target system utilizing the extracted asset creation metadata to access the single copy of the source data on the shared cloud storage, wherein the single copy of the source data is accessible to a plurality of entities associated with the plurality of linked cloud platforms via the shared cloud storage without duplicating the source data on each cloud platform in the plurality of cloud platforms;
the extracted asset creation metadata further comprises permission data for granting permission to the single copy of the source data;
receiving a request for access to the single copy of the source data from a requesting entity associated with a platform in the plurality of linked cloud platforms;
determining whether an entity associated with the request is authorized to access the single copy of the source data using the permission data;
responsive to determining the requesting entity is authorized, granting permission for the entity to access the single copy of the source data;
responsive to determining the requesting entity is unauthorized based on the permission data, denying permission to access the single copy of the source data;
receiving a copy of target data generated on the target system to the shared cloud storage;
extracting second asset creation metadata associated with the received copy of the target data on the shared cloud storage from the target audit log, wherein the second extracted asset creation metadata comprises second location-specific metadata associated with a second location of the received copy of the target data on the shared cloud storage;
migrating the second asset creation metadata to the source audit log, wherein a second entity associated with the source system utilizes the second asset creation metadata to access a single copy of the received target data on the shared cloud storage;
identifying a candidate cloud platform to be added to the plurality of linked cloud platforms;
obtaining platform-specific configuration data associated with the candidate cloud platform;
linking the candidate cloud platform to the shared cloud storage using the platform-specific configuration data, wherein asset creation metadata for accessing data stored on the shared cloud storage is migrated onto a database associated with the candidate cloud platform;
migrating the extracted asset creation metadata to each target audit log associated with each target system in a plurality of target systems within the plurality of linked cloud platforms, wherein a plurality of entities associated with the plurality of target systems is provided with access to a same version of the source data on the shared cloud storage via the single copy of the source data stored on the shared cloud storage;
filtering the extracted asset creation metadata using a set of platform-specific configurable filters associated with the target system;
querying streaming data from the source system substantially in real-time for information from the audit log;
extracting the asset creation metadata from the streaming data;
creating a metadata table in the target database of the target system; and
synchronizing the asset creation metadata in the target data using the extracted asset creation metadata.

At least a portion of the functionality of the various elements in FIG. 1, FIG. 2, FIG. 3, FIG. 4, FIG. 5, and FIG. 6 can be performed by other elements in FIG. 1, FIG. 2, FIG. 3, FIG. 4, FIG. 5, and FIG. 6, or an entity (e.g., processor 106, web service, server, application program, computing device, etc.) not shown in FIG. 1, FIG. 2, FIG. 3, FIG. 4, FIG. 5, and FIG. 6.

In some examples, the operations illustrated in FIG. 7, FIG. 8, and FIG. 9 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of synchronizing metadata across multiple cloud platforms, the method comprising identifying source data generated on a source system in a plurality of linked cloud platforms associated with a shared cloud storage; storing a single copy of the source data on the shared cloud storage, the single copy of the source data stored on the shared cloud storage is accessible by a plurality of linked cloud platforms, the plurality of linked cloud platforms including the source system and a target system; extracting asset creation metadata associated with the single copy of the source data on the shared cloud storage from a source audit log of the source system, wherein the extracted asset creation metadata comprises location-specific metadata associated with a location of the single copy of the source data on the shared cloud storage; migrating the extracted asset creation metadata to a target audit log on a target database associated with the target system; and providing access to an entity associated with the target system utilizing the extracted asset creation metadata to access the single copy of the source data on the shared cloud storage, wherein the single copy of the source data is accessible to a plurality of entities associated with the plurality of linked cloud platforms via the shared cloud storage without duplicating the source data on each cloud platform in the plurality of cloud platforms.

While the aspects of the disclosure have been described in terms of various examples with their associated operations, a person skilled in the art would appreciate that a combination of operations from any number of different examples is also within scope of the aspects of the disclosure.

### EXEMPLARY OPERATING ENVIRONMENT

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for automatically synchronizing asset creation metadata across multiple platforms linked to a shared cloud storage. For example, the elements illustrated in FIG. 1, FIG. 2, FIG. 3, FIG. 4, FIG. 5, and FIG. 6, such as when encoded to perform the operations illustrated in FIG. 7, FIG. 8, and FIG. 9, constitute exemplary means for storing a single copy of source data generated on a source system to a shared cloud storage, the single copy of the source data stored on the shared cloud storage is accessible by a plurality of linked cloud platforms, the plurality of linked cloud platforms including the source system and a target system; exemplary means for extracting asset creation metadata for the single copy of the source data on the shared cloud storage from a source audit log on a source database associated with the source system, wherein the extracted asset creation metadata comprises location-specific metadata associated with a location of the single copy of the source data on the shared cloud storage; and exemplary means for migrating the extracted asset creation metadata to a target audit log on a target database associated with the target system, wherein a first entity associated with the target system utilizes the extracted asset creation metadata to access the single copy of the source data on the shared cloud storage, wherein the single copy of the source data is accessible to a plurality of entities associated with the plurality of linked cloud platforms via the shared cloud storage without duplicating the source data on each cloud platform in the plurality of cloud platforms.

Other non-limiting examples provide one or more computer storage devices having a first computer-executable instructions stored thereon for providing automatic metadata sync across cloud platforms. When executed by a computer, the computer performs operations including identifying source data generated on a source system in a plurality of linked cloud platforms associated with a shared cloud storage; storing a single copy of the source data on the shared cloud storage, the single copy of the source data stored on the shared cloud storage is accessible by a plurality of linked cloud platforms, the plurality of linked cloud platforms including the source system and a target system; extracting asset creation metadata associated with the single copy of the source data on the shared cloud storage from a source audit log of the source system, wherein the extracted asset creation metadata comprises location-specific metadata associated with a location of the single copy of the source data on the shared cloud storage and permission data for granting access permission to the single copy of the source data; migrating the extracted asset creation metadata to a target audit log on a target database associated with the target system; and providing access to an entity associated with the target system utilizing the extracted asset creation metadata to access the single copy of the source data on the shared cloud storage, wherein the single copy of the source data is accessible to a plurality of entities associated with the plurality of linked cloud platforms via the shared cloud storage without duplicating the source data on each cloud platform in the plurality of cloud platforms.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of′ ”only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for multi-platform metadata sync with a single shared data storage, the system comprising:
a processor; and
a computer-readable medium storing instructions that are operative upon execution by the processor to:
store a single copy of source data generated on a source system to a shared cloud storage, the single copy of the source data stored on the shared cloud storage is accessible by a plurality of linked cloud platforms, the plurality of linked cloud platforms including the source system and a target system;
extract asset creation metadata for the single copy of the source data on the shared cloud storage from a source audit log on a source database associated with the source system, wherein the extracted asset creation metadata comprises location-specific metadata associated with a location of the single copy of the source data on the shared cloud storage; and
migrate the extracted asset creation metadata to a target audit log on a target database associated with the target system, wherein a first entity associated with the target system utilizes the extracted asset creation metadata to access the single copy of the source data on the shared cloud storage, wherein the single copy of the source data is accessible to a plurality of entities associated with the plurality of linked cloud platforms via the shared cloud storage without duplicating the source data on each cloud platform in the plurality of cloud platforms.

2. The system of claim 1, wherein the extracted asset creation metadata further comprises permission data for granting permission to the single copy of the source data, and wherein the instructions are further operative to:
receive a request for access to the single copy of the source data from a requesting entity associated with a platform in the plurality of linked cloud platforms;
determine whether an entity associated with the request is authorized to access the single copy of the source data using the permission data;
responsive to determining the requesting entity is authorized, grant permission for the entity to access the single copy of the source data; and
responsive to determining the requesting entity is unauthorized based on the permission data, deny permission to access the single copy of the source data.

3. The system of claim 1, wherein the instructions are further operative to:
receive a copy of target data generated on the target system to the shared cloud storage;
extract second asset creation metadata associated with the received copy of the target data on the shared cloud storage from the target audit log, wherein the second extracted asset creation metadata comprises second location-specific metadata associated with a second location of the received copy of the target data on the shared cloud storage; and
migrate the second asset creation metadata to the source audit log, wherein a second entity associated with the source system utilizes the second asset creation metadata to access a single copy of the received target data on the shared cloud storage.

4. The system of claim 1, wherein the instructions are further operative to:
identify a candidate cloud platform to be added to the plurality of linked cloud platforms;
obtain platform-specific configuration data associated with the candidate cloud platform; and
link the candidate cloud platform to the shared cloud storage using the platform-specific configuration data, wherein asset creation metadata for accessing data stored on the shared cloud storage is migrated onto a database associated with the candidate cloud platform.

5. The system of claim 1, wherein the instructions are further operative to:
migrate the extracted asset creation metadata to each target audit log associated with each target system in a plurality of target systems within the plurality of linked cloud platforms, wherein a plurality of entities associated with the plurality of target systems is provided with access to a same version of the source data on the shared cloud storage via the single copy of the source data stored on the shared cloud storage.

6. The system of claim 1, wherein the instructions are further operative to:
filter the extracted asset creation metadata using a set of platform-specific configurable filters associated with the target system.

7. The system of claim 1, wherein the instructions are further operative to:
query streaming data from the source system substantially in real-time for information from the audit log;
extract the asset creation metadata from the streaming data;
create a metadata table in the target database of the target system; and
synchronize the asset creation metadata in the target data using the extracted asset creation metadata.

8. A method for multi-platform metadata sync with a single shared data storage, the method comprising:
identifying source data generated on a source system in a plurality of linked cloud platforms associated with a shared cloud storage;
storing a single copy of the source data on the shared cloud storage, the single copy of the source data stored on the shared cloud storage is accessible by a plurality of linked cloud platforms, the plurality of linked cloud platforms including the source system and a target system;
extracting asset creation metadata associated with the single copy of the source data on the shared cloud storage from a source audit log of the source system, wherein the extracted asset creation metadata comprises location-specific metadata associated with a location of the single copy of the source data on the shared cloud storage;
migrating the extracted asset creation metadata to a target audit log on a target database associated with the target system; and
providing access to an entity associated with the target system utilizing the extracted asset creation metadata to access the single copy of the source data on the shared cloud storage, wherein the single copy of the source data is accessible to a plurality of entities associated with the plurality of linked cloud platforms via the shared cloud storage without duplicating the source data on each cloud platform in the plurality of cloud platforms.

9. The method of claim 8, wherein the extracted asset creation metadata further comprises permission data for granting permission to the single copy of the source data, and further comprising:
receiving a request for access to the single copy of the source data from a requesting entity associated with a platform in the plurality of linked cloud platforms;
determining whether an entity associated with the request is authorized to access the single copy of the source data using the permission data;
responsive to determining the requesting entity is authorized, granting permission for the entity to access the single copy of the source data; and
responsive to determining the requesting entity is unauthorized based on the permission data, denying permission to access the single copy of the source data.

10. The method of claim 8, further comprising:
receiving a copy of target data generated on the target system to the shared cloud storage;
extracting second asset creation metadata associated with the received copy of the target data on the shared cloud storage from the target audit log, wherein the second extracted asset creation metadata comprises second location-specific metadata associated with a second location of the received copy of the target data on the shared cloud storage; and
migrating the second asset creation metadata to the source audit log, wherein a second entity associated with the source system utilizes the second asset creation metadata to access a single copy of the received target data on the shared cloud storage.

11. The method of claim 8, further comprising:
identifying a candidate cloud platform to be added to the plurality of linked cloud platforms;
obtaining platform-specific configuration data associated with the candidate cloud platform; and
linking the candidate cloud platform to the shared cloud storage using the platform-specific configuration data, wherein asset creation metadata for accessing data stored on the shared cloud storage is migrated onto a database associated with the candidate cloud platform.

12. The method of claim 8, further comprising:
migrating the extracted asset creation metadata to each target audit log associated with each target system in a plurality of target systems within the plurality of linked cloud platforms, wherein a plurality of entities associated with the plurality of target systems is provided with access to a same version of the source data on the shared cloud storage via the single copy of the source data stored on the shared cloud storage.

13. The method of claim 8, further comprising:
filtering the extracted asset creation metadata using a set of platform-specific configurable filters associated with the target system.

14. The method of claim 8, further comprising:
querying streaming data from the source system substantially in real-time for information from the audit log;
extracting the asset creation metadata from the streaming data;
creating a metadata table in the target database of the target system; and
synchronizing the asset creation metadata in the target data using the extracted asset creation metadata.

15. One or more computer storage devices having computer-executable instructions stored thereon, which, upon execution by a computer, cause the computer to perform operations comprising:
identifying source data generated on a source system in a plurality of linked cloud platforms associated with a shared cloud storage;
storing a single copy of the source data on the shared cloud storage, the single copy of the source data stored on the shared cloud storage is accessible by a plurality of linked cloud platforms, the plurality of linked cloud platforms including the source system and a target system;
extracting asset creation metadata associated with the single copy of the source data on the shared cloud storage from a source audit log of the source system, wherein the extracted asset creation metadata comprises location-specific metadata associated with a location of the single copy of the source data on the shared cloud storage and permission data for granting access permission to the single copy of the source data;
migrating the extracted asset creation metadata to a target audit log on a target database associated with the target system; and
providing access to an entity associated with the target system utilizing the extracted asset creation metadata to access the single copy of the source data on the shared cloud storage, wherein the single copy of the source data is accessible to a plurality of entities associated with the plurality of linked cloud platforms via the shared cloud storage without duplicating the source data on each cloud platform in the plurality of cloud platforms.

16. The one or more computer storage devices of claim 15, wherein the operations further comprise:
receiving a request for access to the single copy of the source data from a requesting entity associated with a platform in the plurality of linked cloud platforms;
determining whether an entity associated with the request is authorized to access the single copy of the source data using the permission data;
responsive to determining the requesting entity is authorized, granting permission for the entity to access the single copy of the source data; and
responsive to determining the requesting entity is unauthorized based on the permission data, denying permission to access the single copy of the source data.

17. The one or more computer storage devices of claim 15, wherein the operations further comprise:
identifying a candidate cloud platform to be added to the plurality of linked cloud platforms;
obtaining platform-specific configuration data associated with the candidate cloud platform; and
linking the candidate cloud platform to the shared cloud storage using the platform-specific configuration data, wherein asset creation metadata for accessing data stored on the shared cloud storage is migrated onto a database associated with the candidate cloud platform.

18. The one or more computer storage devices of claim 15, wherein the operations further comprise:
migrating the extracted asset creation metadata to each target audit log associated with each target system in a plurality of target systems within the plurality of linked cloud platforms, wherein a plurality of entities associated with the plurality of target systems is provided with access to a same version of the source data on the shared cloud storage via the single copy of the source data stored on the shared cloud storage.

19. The one or more computer storage devices of claim 15, wherein the operations further comprise:
filtering the extracted asset creation metadata using a set of platform-specific configurable filters associated with the target system.

20. The one or more computer storage devices of claim 15, wherein the operations further comprise:
querying streaming data from the source system substantially in real-time for information from the audit log;
extracting the asset creation metadata from the streaming data;
creating a metadata table in the target database of the target system; and
synchronizing the asset creation metadata in the target data using the extracted asset creation metadata.
